(19) United States
(12) Patent Application Publication
(10) Pub. No.: US 2009/0069512 A1
(43) Pub. Date: Mar. 12, 2009

(54) COMPOSITION AND ASSOCIATED METHOD

(75) Inventors: Gary William Yeager, Rexford, NY (US); Joshua James Stone, Worcester, NY (US); James Manio Silva, Clifton Park, NY (US); Gary Charles Davis, Albany, NY (US)

Correspondence Address: CANTOR COLBURN LLP - SABIC (NORYL), 20 Church Street, 22nd Floor, Hartford, CT, 06103, US

(73) Assignee: GENERAL ELECTRIC COMPANY, SCHENECTADY, NY (US)

(21) Appl. No.: 11/851,557

(22) Filed: Sep. 7, 2007

(51) Int. Cl. C08F 283/00

(52) U.S. Cl. 525/474

(57) ABSTRACT

A composition includes a reaction product of a poly(arylene ether) composition having a plurality of terminal groups and a siloxane composition. Associated article and method are also provided.

### BACKGROUND

1. Technical Field

The invention includes embodiments that may relate to a poly(arylene ether) composition. The invention includes embodiments that may relate to a method of making the poly(arylene ether) composition.

2. Discussion of Art

Poly(arylene ether) resin is a type of plastic known for its excellent water resistance, dimensional stability, and inherent flame retardancy. Properties such as strength, stiffness, chemical resistance, and heat resistance can be tailored by blending it with various other plastics in order to meet the requirements of a wide variety of consumer products.

Polyvinyl chloride resins have long been used as the coating resin in the coated wire and cable industry. However, there is a search for non-halogenated alternatives. One such non-halogenated alternative includes polyethylene compositions. However, useful polyethylene compositions may have high levels of inorganic flame-retardants. Such high loading levels of inorganic flame-retardants may result in deterioration of some mechanical properties and processability.

As electronic devices become smaller and more transportable, there is an increasing need for their cables and wires to be more flexible and durable. There is a need for a flexible thermoplastic composition with good mechanical properties and processability, which is important to the coated wire durability.

It may be desirable to have compositions with properties that differ from those properties of currently available compositions. It may be desirable to have a composition produced by a method that differs from those methods currently available.

### BRIEF DESCRIPTION

In one embodiment, a composition is provided that includes a reaction product of a poly(arylene ether) composition having a plurality of terminal groups and a siloxane composition. In one aspect, a functional group of the siloxane composition is reacted with one or more terminal group of the poly(arylene ether) composition.

In one embodiment, a reaction product is provided. The reactants include a poly(arylene ether) composition having a plurality of terminal groups; and a siloxane composition having a structure represented by Formula (I)

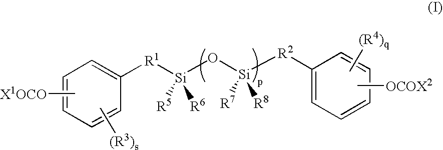

wherein R¹ and R² are a C₁ to about C₂₀ alkylene group; R³ and R⁴, are a hydrogen, a C₁ to about C₂₀ aliphatic radical, a C₃ to about C₂₀ cycloaliphatic radical, or a C₆ to about C₃₀ aromatic radical; s and q are independently at each occurrence an integer in a range of from 0 to 4 inclusive; X¹ and X² are a halogen, a C₁ to about C₂₀ aliphatic radical, a C₃ to about C₂₀ cycloaliphatic radical, or a C₆ to about C₃₀ aromatic radical; and R⁵, R⁶, R⁷ and R⁸ are a hydrogen, a C₁ to about C₂₀ aliphatic radical, a C₃ to about C₂₀ cycloaliphatic radical, or a C₆ to about C₃₀ aromatic radical, and p is an integer greater than or equal to 1.

In one embodiment, a composition is provided that has a structure represented by Formula (VI)

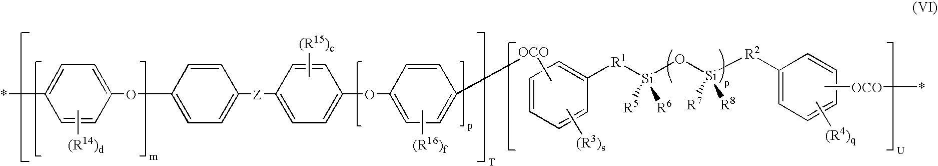

wherein R¹ and R² independently are a C₁ to about C₂₀ alkylene group; R³ and R⁴ are hydrogen, a C₁ to about C₂₀ aliphatic radical, a C₃ to about C₂₀ cycloaliphatic radical, or a C₆ to about C₃₀ aromatic radical; s and q are independently at each occurrence an integer in a range of from 0 to 4 inclusive; and R⁵, R⁶, R⁷ and R⁸ are a hydrogen, a C₁ to about C₂₀ aliphatic radical, a C₃ to about C₂₀ cycloaliphatic radical, or a C₆ to about C₃₀ aromatic radical, and p is an integer greater than or equal to 1; R⁴, R¹⁵ and R¹⁶ are a halogen, a C₁ to about C₂₀ aliphatic radical, a C₃ to about C₂₀ cycloaliphatic radical, or a C₆ to about C₃₀ aromatic radical; d, e and f are independently at each occurrence integers in a range of from 0 to 4; Z is a bond, oxygen, sulfur, a C₁ to about C₂₀ aliphatic radical, or C₆ to about C₃₀ aromatic radical; m and p are integers from 5 to about 100; and T and U independently are integers greater than or equal to 1.

In another embodiment, an article and associated method of making and using the composition and the article are provided.

### DETAILED DESCRIPTION

The invention includes embodiments that relate to a composition. The invention includes embodiments that relate to method of making and/or using the composition and of making and/or using an article made from the composition. Such articles may include electric components.

In one embodiment, a composition includes a reaction product of a functionalized siloxane composition and a poly(arylene ether) composition having a plurality of terminal groups.

A suitable siloxane composition may have a structure represented by the Formula (I):

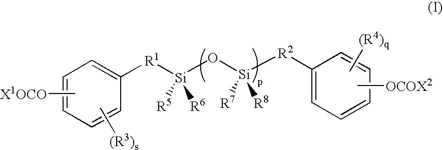

where R¹ and R² are a C₁ to about C₂₀ alkylene group; R³ and R⁴ are hydrogen, a C₁ to about C₂₀ aliphatic radical, a C₃ to about C₂₀ cycloaliphatic radical, or a C₆ to about C₃₀ aromatic radical; s and q are independently at each occurrence an integer in a range of from 0 to 4 inclusive; X¹ and X² are a halogen, a C₁ to about C₂₀ aliphatic radical, a C₃ to about C₂₀ cycloaliphatic radical, or a C₆ to about C₃₀ aromatic radical; and R⁵, R⁶, R⁷ and R⁸ are a hydrogen, a C₁ to about C₂₀ aliphatic radical, a C₃ to about C₂₀ cycloaliphatic radical, or a C₆ to about C₃₀ aromatic radical, and p is an integer greater than or equal to 1.

In one embodiment, R¹ and R² are a C₁ to about C₂₀ alkylene group; R³ and R⁴ are a hydrogen, a C₁ to about C₂₀ aliphatic radical, a C₃ to about C₂₀ cycloaliphatic radical, or a C₆ to about C₃₀ aromatic radical; s and q are independently at each occurrence an integer in a range of from 0 to 4 inclusive; X¹ and X² are a halogen, a trifluoromethyl, a cyano, or an epoxy group and R⁵, R⁶, R⁷ and R⁸ are a hydrogen, a C₁ to about C₂₀ aliphatic radical, a C₃ to about C₂₀ cycloaliphatic radical, or a C₆ to about C₃₀ aromatic radical, and p is an integer in a range of from 1 to about 200 inclusive.

In one embodiment, the siloxane composition has a structure represented by Formula (I) where R¹ and R² are a C₁ to about C₁₀ alkylene group, a C₁ to about C₁₀ alkylene group substituted by one or more C₁ to about C₁₀ alkyl or aryl groups, an oxygen atom, an oxyalkyleneoxy moiety —O—(CH₂)ₜ—O—, or an oxyalkylene moiety —O—(CH₂)ₜ—, where t is an integer from 2-20. R³ and R⁴ are each independently at each occurrence a halogen, C₁ to about C₆ alkoxy, C₁ to about C₆ alkyl, or C₆ to about C₁₀ aryl and s and q are independently integers from 0 to 4. R⁵, R⁶, R⁷ and R⁸ are each independently at each occurrence C₁ to about C₆ alkyl aryl, C₂ to about C₆ alkenyl, cyano, trifluoropropyl, or styrenyl; and p is an integer in a range of from 1 to about 200 inclusive.

Another suitable siloxane composition may have a structure represented by the Formula (II):

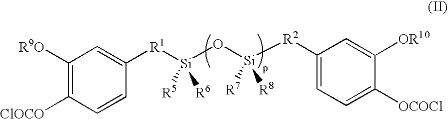

where R⁹ and R¹⁰ are a C₁ to about C₂₀ aliphatic radical, a C₃ to about C₂₀ cycloaliphatic radical, or a C₆ to about C₃₀ aromatic radical, and p is an integer in a range of from 1 to about 200 inclusive. In a particular embodiment, R⁹ and R¹⁰ are methyl radicals.

The siloxane composition may include a bischloroformate of a siloxane bisphenol. As used herein, the term “bischloroformate of siloxane bisphenol” refers to bischloroformate prepared from siloxane-containing bisphenol or equivalent. The term “siloxane bischloroformate” refers to a bischloroformate including one or more siloxane units. Siloxane bischloroformates includes, as a subgroup, bischloroformates of siloxane bisphenols.

Non-limiting examples of siloxane bisphenols include eugenol siloxane bisphenol, 4-allyl-2-methylphenol siloxane bisphenol, 4-allylphenol siloxane bisphenol, 2-allylphenol siloxane bisphenol, 4-allyloxyphenol siloxane bisphenol, and 4-vinylphenol siloxane bisphenol. Some materials are named after the aliphatically unsaturated phenols from which they are prepared. Thus, the name eugenol siloxane bisphenol denotes a siloxane bisphenol prepared from eugenol (4-allyl-2-methoxyphenol). Similarly, the name 4-allyl-2-methylphenol siloxane bisphenol indicates the siloxane bisphenol prepared from 4-allyl-2-methylphenol. The other names given follow the same naming pattern. The disodium salt of a siloxane bisphenol is an example of a species that would function as the equivalent of a siloxane bisphenol. In one embodiment, the siloxane composition may be prepared by using eugenol siloxane bisphenol. As used herein, the term “d-50 eugenol siloxane bisphenol” indicates that a siloxane has an average value of the integer p that is about 50. A eugenol siloxane bisphenol having a value of p of about 50 may be referred to by the abbreviation “EuSiD50”. In one embodiment, the eugenol siloxanes may include a mixture of the isomeric structures of the siloxane composition represented by Formula (II). In another embodiment, the eugenol siloxanes may include a mixture of siloxane bisphenol homologues having an average value of p of about 50.

The siloxane composition may include one or more reactive functional groups. In one embodiment, the siloxane composition contains less than 10 percent residual hydroxy end groups as defined. The term “residual hydroxy end groups” refers to those hydroxy groups present in the starting siloxane bisphenol, and which are not converted to the corresponding chloroformate groups in the product bischloroformate. In one embodiment, the siloxane composition contains less than 5 percent residual hydroxy end groups. In one embodiment, the siloxane composition contains less than 1 percent residual hydroxy end groups. In another embodiment, the siloxane composition of structure (II) includes fewer than 10 percent hydroxy end groups, and less than 0.5 percent carbonate groups.

The siloxane composition may be greater than about 1 weight percent based on the total weight of the composition. In one embodiment, the siloxane composition may be present in a range of from about 1 weight percent to about 15 weight percent, from about 15 weight percent to about 30 weight percent from about 30 weight percent to about 75 weight percent, or from about 75 weight percent to about 95 weight percent based on the total weight of the composition. Alternatively, the siloxane composition may be present in a range of from about 5 weight percent to about 30 weight percent, from about 30 weight percent to about 80 weight percent, or from about 80 weight percent to about 95 weight percent based on the total weight of the composition.

In one embodiment, the composition includes a poly(arylene ether) having a plurality of terminal groups and having a structure represented by Formula (III)

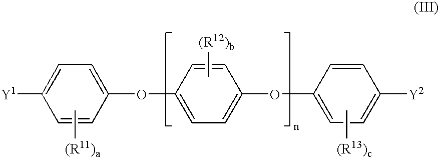

where R¹¹, R¹² and R¹³ may be hydrogen, a halogen, a C₁ to about C₂₀ aliphatic radical, a C₃ to about C₂₀ cycloaliphatic radical, or a C₆ to about C₃₀ aromatic radical; and Y¹ and Y² are a reactive functional group that is a terminal groups, a, b and c are independently at each occurrence an integer in a range of from 0 to 4; and n is an integer from 3 to about 200 inclusive.

In another embodiment, the poly(arylene ether) may have one or more aminoalkyl containing end groups. These aminoalkyl containing end groups may be located in an ortho position to the hydroxy group. In another embodiment, the poly(arylene ether) may include phenol residues such as aminophenol residues, bisphenol residues such as those derived from bisphenol-A (BPA) or quinine residues such as those derived from tetramethyldiphenoquinone (TMDQ). The tetramethyldiphenoquinone (TMDQ) may be produced during oxidative polymerization of phenols in the production of polyarylene ethers and may be incorporated during polymerization and/or in a subsequent reaction. In one embodiment, the quinine residues may have a structure represented by Formula (IV)

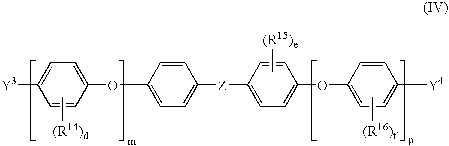

where R¹⁴, R¹⁵ and R¹⁶ may be hydrogen, a halogen, a C₁ to about C₂₀ aliphatic radical, a C₃ to about C₂₀ cycloaliphatic radical, or a C₆ to about C₃₀ aromatic radical; and Y³ and Y⁴ are a reactive functional group that is a terminal groups; d, e and f are independently at each occurrence an integer in a range of from 0 to 4; Z may be a bond, oxygen, sulfur, a C₁ to about C₂₀ aliphatic radical, or C₆ to about C₃₀ aromatic radical; and m and p are integers from 5 to about 100 inclusive.

The poly(arylene ether) may be a homopolymer, a copolymer, a graft copolymer, an ionomer, or a block copolymer. Within the composition may be a polyarylether that may be a homopolymer, a random copolymer, a block copolymer, or a graft copolymer. Copolymers are polymers that comprise structural units derived from more than one monomer. Block copolymers comprise structural units derived from at least two different monomers, wherein the structural units from each monomer form blocks of linked chains. Alternating copolymers comprise structural units derived from two monomers, and the structural units from each of the two monomers are substantially alternating along the length of the polymer chain. Graft copolymers comprise structural units derived from at least two monomers, wherein the structural units derived from one monomer form part of the main chain, and structural units derived from the other monomers form part of the side chain. Poly(arylene ether)s include polyphenylene ethers comprising 2,6-dimethyl-1,4-phenylene ether units optionally in combination with 2,3,6-trimethyl-1,4-phenylene ether units.

The poly(arylene ether) may be prepared by the oxidative coupling of monohydroxyaromatic composition(s) such as 2,6-xylenol and/or 2,3,6-trimethylphenol. Exemplary catalyst systems employed for the coupling reaction may include heavy metal composition(s) such as a copper, manganese or cobalt composition, usually in combination with various other materials such as a secondary amine, tertiary amine, halide or combination of two or more of the foregoing. In some embodiments, the poly(arylene ether) may include poly(2,6-dimethyl-1,4-phenylene ether) or poly(2,6-dimethyl-1,4-phenylene ether-co-2,3,6-trimethyl-1,4-phenylene ether).

In some embodiments, the poly(arylene ether) includes a bifunctional poly(arylene ether). In one embodiment, bifunctional poly(arylene ether) may be a bifunctional poly(phenylene ether) composition. With respect to an individual poly(arylene ether) molecule, the term “bifunctional” means that the molecule comprises two phenolic hydroxy groups. With respect to a poly(arylene ether) resin, the term “bifunctional” means that the resin comprises, on average, 1.6 to 2.4 phenolic hydroxy groups per poly(arylene ether) molecule. In some embodiments, the bifunctional poly(arylene ether) comprises, on average, 1.8 to 2.2 phenolic hydroxy groups per poly(arylene ether) molecule.

A suitable poly(arylene ether) composition may have a structure represented by Formula (V)

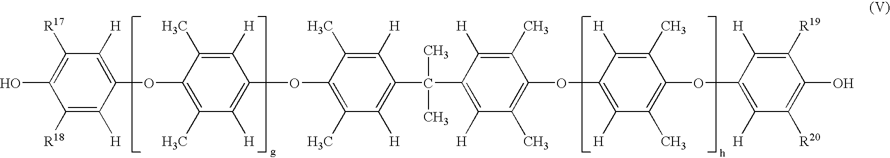

where R¹⁷, R¹⁸, R¹⁹ and R²⁰ are methyl or di-n-butylaminomethyl; g and h are integers in a range of from 0 to about 200 inclusive. In one embodiment, bifunctional poly(arylene ether)s having the above formula may be synthesized by oxidative copolymerization of 2,6-xylenol and 2,2-bis(3,5-dimethyl-4-hydroxyphenyl)propane in the presence of a catalyst comprising di-n-butylamine.

In one embodiment, the bifunctional poly(arylene ether) may be prepared by a process comprising oxidatively polymerizing a monohydric phenol in the presence of a catalyst under conditions suitable to form a corresponding poly(arylene ether) and a corresponding diphenoquinone; separating the poly(arylene ether) and the diphenoquinone from the catalyst; and equilibrating the poly(arylene ether) and the diphenoquinone to form a poly(arylene ether) having two terminal hydroxy groups. An illustrative example of a corresponding poly(arylene ether) is poly(2,6-dimethyl-1,4-phenylene ether) prepared from oxidative polymerization of 2,6-dimethylphenol. An illustrative example of a corresponding diphenoquinone is 3,3′,5,5′-tetramethyl-4,4′-diphenoquinone formed by oxidation of 2,6-dimethylphenol.

In another embodiment, the bifunctional poly(arylene ether) can also be prepared by a redistribution reaction in which a monofunctional poly(arylene ether) is equilibrated with a dihydric phenol, optionally in the presence of an oxidizing agent.

The poly(arylene ether) may be characterized by number average molecular weight (Mₙ) and weight average molecular weight (M_{w}). The various average molecular weights Mₙ and M_{w} are determined by techniques such as gel permeation chromatography. Suitable molecular weights of the poly(arylene ether) used to form the composition may be greater than about 1,000 g/mol. In some embodiments, the molecular weight of the poly(arylene ether) used to form the composition may be less than about 200,000 g/mol. In one embodiment, the molecular weight of the polymer is in a range of from about 1,000 to about 40,000 g/mol, from about 40,000 to about 80,000 g/mol, from about 80,000 to about 120,000 g/mol, or from about 120,000 g/mol to about 200,000 g/mol. In one embodiment, the poly(arylene ether) has a number average molecular weight of at least about 5,000 g/mol. In another embodiment, the poly(arylene ether) has a number average molecular weight of in a range of from 10,000 to about 150,000 g/mol. The poly(arylene ether) may have monomodal or polymodal molecular weight distributions and poly(arylene ether) with monomodal or bimodal distributions are useful. The polymer may be a blend of two or more aforementioned poly(arylene ether). Each poly(arylene ether) molecule in the blend may have similar or differing molecular weights, molecular weight distributions, and types and levels of functionality.

The poly(arylene ether) may be greater than about 1 weight percent based on the total weight of the composition. In one embodiment, the poly(arylene ether) may be present in a range of from about 1 weight percent to about 25 weight percent, from about 25 weight percent to about 50 weight percent from about 50 weight percent to about 75 weight percent, or from about 75 weight percent to about 95 weight percent based on the total weight of the composition. Alternatively, the poly(arylene ether) may be present in a range of from about 5 weight percent to about 95 weight percent based on the total weight of the composition, or from in a range of from about 40 weight percent to about 80 weight percent based on the total weight of the composition.

In one embodiment, the poly(arylene ether) is substantially amine free. By “substantially amine free” it is meant that the flow rate weighted average of the amine levels, including but not limited to triethylamines, in all feed streams is maintained at less than 50 parts per million (ppm) during the preparation process.

In one embodiment, a composition is provided that is one reaction product available by the reaction of the above-identified reactants. The structure is represented by Formula (VI)

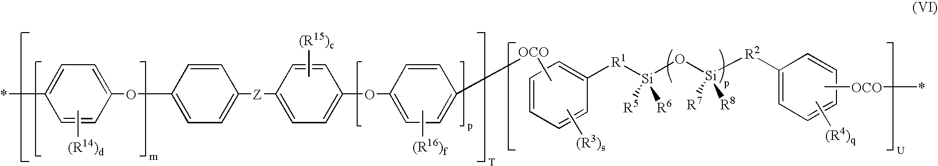

wherein R¹ and R² independently are a C₁ to about C₂₀ alkylene group; R³ and R⁴ are hydrogen, a C₁ to about C₂₀ aliphatic radical, a C₃ to about C₂₀ cycloaliphatic radical, or a C₆ to about C₃₀ aromatic radical; s and q are independently at each occurrence an integer in a range of from 0 to 4 inclusive; and R⁵, R⁶, R⁷ and R⁸ are a hydrogen, a C₁ to about C₂₀ aliphatic radical, a C₃ to about C₂₀ cycloaliphatic radical, or a C₆ to about C₃₀ aromatic radical, and p is an integer greater than or equal to 1; R⁴, R¹⁵ and R¹⁶ are a halogen, a C₁ to about C₂₀ aliphatic radical, a C₃ to about C₂₀ cycloaliphatic radical, or a C₆ to about C₃₀ aromatic radical; d, e and f are independently at each occurrence integers in a range of from 0 to 4; Z is a bond, oxygen, sulfur, a C₁ to about C₂₀ aliphatic radical, or C₆ to about C₃₀ aromatic radical; m and p are integers from 5 to about 100; and T and U independently are integers greater than or equal to 1.

Shown in Formula VI is an AB block copolymer. Other embodiments may include ABA, BAB, ABBA block copolymers, and the like.

The additives may be selected to affect the characteristics and properties of an article made from the composition. Mixtures of additives may be used. Such additives may be mixed at a suitable time during the mixing of the components for forming the composition. Exemplary additives include lubricants, flow modifiers, pigments, dyes, colorants, extenders, UV light stabilizers, anti-oxidants, impact modifiers, thixotropes, heat stabilizers, antidrip agents, plasticizers, mold release agents, nucleating agents, optical brighteners, anti-static agents, and blowing agents and the like. In another embodiment, the composition may further contain a flame retardant or a flame proofing agent. If present, each additive amount may be in a range of from about 0.1 weight percent to about 20 weight percent, based on the total weight of composition. Naturally, additions may be made so as to avoid negative impact to a desirable characteristic of the composition.

Alternatively, the thermoplastic composition may be essentially free of chlorine and bromine. Essentially free of chlorine and bromine as used herein refers to materials produced without the intentional addition of chlorine or bromine or chlorine or bromine containing materials. It is understood however that in facilities that process multiple products a certain amount of cross contamination may occur resulting in bromine and/or chlorine levels may be on the parts per million by weight scale. Essentially free of bromine and chlorine may be defined as having a bromine and/or chlorine content of less than about 100 parts per million by weight (ppm), less than about 75 ppm, or less than about 50 ppm. When this definition is applied to the fire retardant it is based on the total weight of the fire retardant. When this definition is applied to the thermoplastic composition it is based on the total weight of the polymer portion of the composition and fire retardant.

Neutralizing additives may include one or more of melamine, polyvinylpyrrolidone, dicyandiamide, triallyl cyanurate, urea derivatives, hydrazine derivatives, amines, polyamides, and polyurethanes; alkali metal salts and alkaline earth metal salts of higher fatty acids, such as for example, calcium stearate, calcium stearoyl lactate, calcium lactate, zinc stearate, magnesium stearate, sodium ricinoleate, and potassium palmitate; antimony pyrocatecholate, zinc pyrocatecholate, and hydrotalcites and synthetic hydrotalcites. Hydroxy carbonates, magnesium zinc hydroxycarbonates, magnesium aluminum hydroxycarbonates, and aluminum zinc hydroxycarbonates; as well as metal oxides, such as zinc oxide, magnesium oxide and calcium oxide; peroxide scavengers, such as, e.g., (C10-C20) alkyl esters of beta-thiodipropionic acid, such as for example the lauryl, stearyl, myristyl or tridecyl esters; mercapto benzimidazole or the zinc salt of 2-mercaptobenzimidazole, zinc-dibutyldithiocarbamate, dioctadecyldisulfide, and pentaerythritol tetrakis(.beta.-dodecylmercapto)propionate may be used. When present, the neutralizers may be used in an amount in a range of from about 0.1 to about 20 parts by weight, or from about 20 to about 50 parts by weight, based on 100 parts by weight of the polymer portion of the composition.

In one embodiment the optional additive is a polyamide stabilizer. Such a polyamide stabilizer may include copper salts in combination a phosphorus compositions or a salt of divalent manganese. Examples of sterically hindered amines include, but are not restricted to, triisopropanol amine or the reaction product of 2,4-dichloro-6-(4-morpholinyl)-1,3,5-triazine with a polymer of 1,6-diamine, N,N′-bis(-2,2,4,6-tetramethyl-4-piperidinyl)hexane.

Other additives may include antioxidants, UV absorbers, and light stabilizers. Suitable antioxidants may include i) alkylated monophenols, for example: 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(alpha-methylcyclohexyl)-4,6 dimethylphenol, 2,6-di-octadecyl-4-methylphenol, 2,4,6,-tricyclohexyphenol, 2,6-di-tert-butyl-4-methoxymethylphenol; ii) alkylated hydroquinones, for example, 2,6-di-tert-butyl-4-methoxyphenol, 2,5-di-tert-butyl-hydroquinone, 2,5-di-tert-amyl-hydroquinone, 2,6-diphenyl-4-octadecyloxyphenol; iii) hydroxylated thiodiphenyl ethers; iv) alkylidene-bisphenols; v) benzyl compositions, for example, 1,3,5-tris-(3,5-di-tert-butyl-4-hydroxybenzyl)-2,4,6-trimethylbenzene; vi) acylaminophenols, for example, 4-hydroxy-lauric acid anilide; vii) esters of beta-(3,5-di-tert-butyl-4-hydroxyphenol)-propionic acid with monohydric or polyhydric alcohols; viii) esters of beta-(5-tert-butyl-4-hydroxy-3-methylphenyl)-propionic acid with monohydric or polyhydric alcohols; vii) esters of beta-(5-tert-butyl-4-hydroxy-3-methylphenyl)propionic acid with mono- or polyhydric alcohols, e.g., with methanol, diethylene glycol, octadecanol, triethylene glycol, 1,6-hexanediol, pentaerythritol, neopentyl glycol, tris(hydroxyethyl)isocyanurate, thiodiethylene glycol, N,N-bis(hydroxyethyl)oxalic acid diamide.

Suitable UV absorbers and light stabilizers may include i) 2-(2′-hydroxyphenyl)-benzotriazoles, for example, the 5′methyl-, 3′5′-di-tert-butyl-, 5′-tert-butyl-, 5′(1,1,3,3-tetramethylbutyl)-, 5-chloro-3′,5′-di-tert-butyl-, 5-chloro-3′tert-butyl-5′methyl-, 3′sec-butyl-5′tert-butyl-, 4′-octoxy, 3′,5′-ditert-amyl-3′,5′-bis-(alpha, alpha-dimethylbenzyl)-derivatives; ii) 2,2,2-hydroxy-benzophenones, for example, the 4-hydroxy-4-methoxy-4-octoxy, 4-decloxy-, 4-dodecyloxy-, 4-benzyloxy, 4,2′,4′-trihydroxy- and 2′hydroxy-4,4′-dimethoxy derivative, and iii) esters of substituted and unsubstituted benzoic acids for example, phenyl salicylate, 4-tert-butylphenyl-salicilate, octylphenyl salicylate, dibenzoylresorcinol, bis(4-tert-butylbenzoyl)-resorcinol, benzoylresorcinol, 2,4-di-tert-butyl-phenyl-3,5-di-tert-butyl-4-hydroxybenzoate and hexadecyl-3,5-di-tert-butyl-4-hydroxybenzoate.

Other suitable additives may include plasticizers, lubricants, and/or mold release agents. These additives may include one or more of phthalic acid esters; tris-(octoxycarbonylethyl)isocyanurate; tristearin; di- or polyfunctional aromatic phosphates such as resorcinol tetraphenyl diphosphate (RDP), the bis(diphenyl)phosphate of hydroquinone and the bis(diphenyl)phosphate of bisphenol-A; poly-alpha-olefins; epoxidized soybean oil; silicones, including silicone oils; sodium, calcium or magnesium salts of fatty acids such as lauric acid, palmitic acid, oleic acid or stearic acid; esters, for example, fatty acid esters such as alkyl stearyl esters, e.g., methyl stearate; stearyl stearate, pentaerythritol tetrastearate, and the like; mixtures of methyl stearate and hydrophilic and hydrophobic nonionic surfactants including polyethylene glycol polymers, polypropylene glycol polymers, and copolymers thereof, e.g., methyl stearate and polyethylene-polypropylene glycol copolymers in a suitable solvent; waxes such as beeswax, montan wax, paraffin wax, EBS wax, or the like. Such materials may be used in amounts in a range of from about 0.1 parts by weight to about 20 parts by weight, based on 100 parts by weight of the polymer portion of the composition.

The term “antistatic agent” refers to monomeric, oligomeric, or polymeric materials that may be processed into polymer resins and/or sprayed onto materials or articles to improve conductive properties and overall physical performance. Examples of monomeric antistatic agents include glycerol monostearate, glycerol distearate, glycerol tristearate, ethoxylated amines, primary, secondary and tertiary amines, ethoxylated alcohols, alkyl sulfates, alkylarylsulfates, alkylphosphates, alkylaminesulfates, alkyl sulfonate salts such as sodium stearyl sulfonate, sodium dodecylbenzenesulfonate or the like, quaternary ammonium salts, quaternary ammonium resins, imidazoline derivatives, sorbitan esters, ethanolamides, betaines, or the like, or combinations including exemplary polymeric antistatic agents include certain polyesteramides polyether-polyamide (polyetheramide) block copolymers, polyetheresteramide block copolymers, polyetheresters, or polyurethanes, each containing polyalkylene glycol moieties polyalkylene oxide units such as polyethylene glycol, polypropylene glycol, polytetramethylene glycol, and the like. Such polymeric antistatic agents are commercially available, for example PELESTAT 6321 (Sanyo) or PEBAX MH1657 (Atofina), Irgastat P18 and P22 (Ciba-Geigy). Other polymeric materials that may be used as antistatic agents are inherently conducting polymers such as polyaniline (commercially available as PANIPOL®EB from Panipol), polypyrrole and polythiophene (commercially available from Bayer), which retain some of their intrinsic conductivity after melt processing at elevated temperatures. In one embodiment, carbon fibers, carbon nanofibers, carbon nanotubes, or carbon black, may be used to render the composition electrostatically dissipative. Antistatic agents may be present in an amount in a range of from about 0.05 parts by weight to about 20 parts by weight, based on 100 parts by weight of the total composition.

Dyes or pigments may be used to give a background coloration. The dyes may be organic materials that are soluble in the composition, while pigments may be organic complexes or even inorganic compositions or complexes that may be insoluble in the composition. These organic dyes and pigments include the following classes and examples: furnace carbon black, titanium oxide, zinc sulfide, phthalocyanine blues or greens, anthraquinone dyes, scarlet 3b Lake, azo compositions and acid azo pigments, quinacridones, chromophthalocyanine pyrrols, halogenated phthalocyanines, quinolines, heterocyclic dyes, perinone dyes, anthracenedione dyes, thioxanthene dyes, parazolone dyes, polymethine pigments and others.

Suitable pigments include for example, inorganic pigments such as metal oxides and mixed metal oxides such as zinc oxide, titanium dioxides, iron oxides or the like; sulfides such as zinc sulfides, or the like; aluminates; sodium sulfo-silicates sulfates, chromates, or the like; carbon blacks; zinc ferrites; ultramarine blue; Pigment Brown 24; Pigment Red 101; Pigment Yellow 119; organic pigments such as azos, di-azos, quinacridones, perylenes, naphthalene tetracarboxylic acids, flavanthrones, isoindolinones, tetrachloroisoindolinones, anthraquinones, anthanthrones, dioxazines, phthalocyanines, and azo lakes; Pigment Blue 60, Pigment Red 122, Pigment Red 149, Pigment Red 177, Pigment Red 179, Pigment Red 202, Pigment Violet 29, Pigment Blue 15, Pigment Green 7, Pigment Yellow 147 and Pigment Yellow 150, or combinations. Suitable dyes include organic materials such as, coumarin dyes such as coumarin 460 (blue), coumarin 6 (green), nile red or the like; lanthanide complexes; hydrocarbon and substituted hydrocarbon dyes; polycyclic aromatic hydrocarbon dyes; scintillation dyes such as oxazole or oxadiazole dyes; aryl- or heteroaryl-substituted poly(C₂-C₈) olefin dyes; carbocyanine dyes; indanthrone dyes; phthalocyanine dyes; oxazine dyes; carbostyryl dyes; napthalenetetracarboxylic acid dyes; porphyrin dyes; bis(styryl)biphenyl dyes; acridine dyes; anthraquinone dyes; cyanine dyes; methine dyes; arylmethane dyes; azo dyes; indigoid dyes, thioindigoid dyes, diazonium dyes; nitro dyes; quinone imine dyes; aminoketone dyes; tetrazolium dyes; thiazole dyes; perylene dyes, perinone dyes; bis-benzoxazolylthiophene (BBOT); triarylmethane dyes; xanthene dyes; thioxanthene dyes; naphthalimide dyes; lactone dyes; fluorophores such as anti-stokes shift dyes which absorb in the near infrared wavelength and emit in the visible wavelength, or the like; luminescent dyes such as 7-amino-4-methyl coumarin; 3-(2′-benzothiazolyl)-7-diethyl amino coumarin; 2-(4-biphenylyl)-5-(4-t-butyl phenyl)-1,3,4-oxadiazole; 2,5-bis-(4-biphenylyl)oxazole; 2,2′-dimethyl-p-quarter phenyl; 2,2-dimethyl-p-terphenyl; 3,5,3″″,5″″-tetra-t-butyl-p-quinque phenyl; 2,5-diphenyl furan; 2,5-diphenyl oxazole; 4,4′-diphenyl stilbene; 4-dicyano methylene-2-methyl-6-(p-dimethyl amino styryl)-4H-pyran; 1,1′-diethyl-2,2′-carbocyanine iodide; 3,3′-diethyl-4,4′,5,5′-dibenzo thiatricarbo cyanine iodide; 7-dimethyl amino-1-methyl-4-methoxy-8-azaquinolone-2; 7-dimethyl amino-4-methyl quinolone-2; 2-(4-(4-dimethyl amino phenyl)-1,3-butadienyl)-3-ethylbenzo thiazolium perchlorate; 3-diethyl amino-7-diethylimino phenoxazonium perchlorate; 2-(1-naphthyl)-5-phenyl oxazole; 2,2′-p-phenylen-bis(5-phenyloxazole); rhodamine 700; rhodamine 800; pyrene; chrysene; rubrene; coronene, or the like.

Where a foam is desired, suitable blowing agents include low boiling solids and liquids. Such low boiling materials can include halohydrocarbons that generate carbon dioxide at low temperatures. Other suitable blowing agents are solid at room temperature and generate gases when heated to temperatures higher than their decomposition temperatures. The generated gases can include nitrogen, carbon dioxide, and ammonia gas. Suitable solid blowing agents can include azodicarbonamide, metal salts of azodicarbonamide, 4,4′ oxybis(benzene sulfonyl hydrazide), sodium bicarbonate, ammonium carbonate, or the like. Blowing agents may be used in an amount that is greater than about 0.01 parts per hundred (PPH) or in an amount that is less than about 50 PPH. In one embodiment, the amount is in a range of from about 0.01 parts by weight to about 1 part by weight, from about 1 part by weight to about 15 parts by weight, from about 15 parts by weight to about 35 parts by weight, from about 35 parts by weight to about 50 parts by weight, based on 100 parts by weight of the polymer portion of the composition. The use of the blowing agent additive, as noted above, can create a foamed polymeric substrate. The foamed substrate can have an open cell topology such that the foam cells are the equivalent in some embodiments, to the pores disclosed with regard to the other embodiments.

In one embodiment, a method to make the composition by reacting a poly(arylene ether) composition having a plurality of terminal groups with a siloxane composition having a structure represented by Formula (I).

The reaction may be conducted in the presence of a solvent or in neat conditions without the solvent. If used, the solvent may added to at least one of the poly(arylene ether) composition or the siloxane composition prior to reacting. The organic solvent used in the above process should be capable of dissolving the poly(arylene ether) or the siloxane composition to an extent of at least 0.01 g per mL at 25 degrees Celsius. A solvent may be used as a viscosity modifier, or to facilitate the dispersion and/or suspension of the filler composition.

Suitable liquid aprotic polar solvents include amide solvents. Suitable amide solvents may include N-methyl-2-pyrrolidone; N-acetyl-2-pyrrolidone; N,N′-dimethyl formamide; N,N′-dimethyl acetamide; N,N′-dimethyl propionic acid amide; N,N′-diethyl propionic acid amide; tetramethyl urea; tetraethyl urea; hexamethylphosphor triamide; N-methyl caprolactam; and the like. Other suitable liquid aprotic polar solvents may include propylene carbonate, ethylene carbonate, butyrolactone, acetonitrile, benzonitrile, nitromethane, and nitrobenzene. Suitable polar solvents may include water, methanol, acetonitrile, nitromethane, ethanol, propanol, isopropanol, butanol, or the like, may be used. Other non-polar solvents may include benzene, toluene, halogenated aromatic solvents, methylene chloride, carbon tetrachloride, chlorobenzene, o-dichlorobenzene, chloroform, 1,2-dichloroethane, hexane, diethyl ether, dioxane, and tetrahydrofuran. The solvent may be evaporated before, during and/or after the blending of the composition. In one embodiment, after completing the reaction, the composition may be separated from the inorganic salts precipitated into a nonsolvent and collected by filtration and drying, under vacuum and/or at high temperature.

After blending, the solvent may removed by one or both of heating or application of vacuum. Removal of the solvent from the composition may be measured and quantified by an analytical technique such as, infra-red spectroscopy, nuclear magnetic resonance spectroscopy, thermogravimetric analysis, differential scanning calorimetric analysis, and the like.

In one embodiment, a catalyst may be employed that can facilitate a reaction between the terminal groups and the chloroformate groups. The catalyst may be an acidic, or basic or a transition metal based catalyst. The catalyst can be an alkaline earth metal oxides such as magnesium oxides, calcium oxide, barium oxide and zinc oxide; alkali and alkaline earth metal salts; a Lewis catalyst such as tin or titananium compositions; a nitrogen-containing composition such as tetra-alkyl ammonium hydroxides used like the phosphonium analogues, e.g., tetra-alkyl phosphonium hydroxides or acetates. The Lewis acid catalysts and the aforementioned metal oxide or salts can be used simultaneously. Suitable catalyst systems for the preparation of poly(arylene ether) by oxidative coupling include those that contain for example copper, manganese or cobalt. Selection may be based on the desired end-use application.

In one embodiment, the catalyst systems includes of those containing a copper composition. The catalyst may be a combination of cuprous or cupric ions, halide (e.g., chloride, bromide or iodide) ions and an amine. In one embodiment, the catalysts may contain manganese compositions. The catalyst may be alkaline systems in which divalent manganese is combined with such anions as halide, alkoxide or phenoxide. The manganese may be present as a complex with one or more complexing and/or chelating agents such as dialkylamines, alkanolamines, alkylenediamines, o-hydroxyaromatic aldehydes, o-hydroxyazo compositions, hydroxyoximes (monomeric and polymeric), o-hydroxyaryl oximes and diketones. Other suitable catalyst may include cobalt-containing catalyst systems. In one embodiment, a phase transfer catalyst may also be employed. Examples of phase transfer catalysts include hexaalkylguanidinium salts and bis-guanidinium salts, an anionic species such as halide, mesylate, tosylate, tetrafluoroborate, or acetate as a charge-balancing counterion(s). Other suitable phase transfer catalysts may include p-dialkylamino-pyridinium salts, bis-dialkylaminopyridinium salts, bis-quaternary ammonium salts, bis-quaternary phosphonium salts, and phosphazenium salts.

In one embodiment, the reaction may be carried out at ambient temperature. In another embodiment, the reaction may be carried out at a temperature lower than 100 degrees Celsius. In an alternate embodiment, the reaction may be conducted at a temperature greater than about 100 degrees Celsius. Other suitable reactions may be conducted at a temperature that is less than about 300 degrees Celsius. In one embodiment, the reaction temperature is in a range of from about from 100 degrees Celsius to about 120 degrees Celsius, from about from 120 degrees Celsius to about 140 degrees Celsius, from about from 140 degrees Celsius to about 160 degrees Celsius, from about from 160 degrees Celsius to about 180 degrees Celsius, from about from 180 degrees Celsius to about 200 degrees Celsius, from about from 200 degrees Celsius to about 250 degrees Celsius, from about from 250 degrees Celsius to about 290 degrees Celsius, or greater than 290 degrees Celsius. The reaction can be conducted for a time period in a range of from about 1 hour to about 72 hours.

In one embodiment, reacting may include simple mixing or blending of the reactants. The mixing or blending can be performed in solid-form, melt form, or by solution mixing. There may be two distinct mixing steps: a premixing step and a melt-mixing step. In the premixing step, the dry ingredients may be mixed together. The premixing step may be performed using a tumbler mixer or ribbon blender. However, if desired, the premix may be manufactured using a high shear mixer such as a Henschel mixer or similar high intensity device. The premixing step may be followed by a melt mixing step in which the premix is melted and mixed again as a melt. Alternatively, the premixing step may be omitted, and raw materials may be added directly into the feed section of a melt mixing device, preferably via multiple feeding systems.

Solid-blending or melt-blending may involve the use of one or more of shear force, extensional force, compressive force, ultrasonic energy, electromagnetic energy, or thermal energy.

Reacting may also include extruding that is conducted in a processing equipment wherein the aforementioned forces may be exerted by one or more of single screw, multiple screws, intermeshing co-rotating or counter rotating screws, non-intermeshing co-rotating or counter rotating screws, reciprocating screws, screws with pins, barrels with pins, rolls, rams, or helical rotors. The materials may be mixed by mixing equipment such as dough mixers, chain may mixers, planetary mixers, twin screw extruder, two or three roll mill, BUSS kneader, HENSCHEL, helicones, ROSS mixer, BANBURY, roll mills, molding machines such as injection molding machines, vacuum forming machines, blow molding machine, or the like. Blending may be performed in batch, continuous, or semi-continuous mode. With a batch mode reaction, for instance, all of the reactant components may be combined and reacted until most of the reactants may be consumed. The reaction may be stopped and additional reactant added. With continuous conditions, the reaction does not have to be stopped to add more reactants. Solution blending may also use additional energy such as shear, compression, ultrasonic vibration, or the like to promote homogenization of the filler in the underfill composition. A filled or an unfilled composition may be contacted with a cure catalyst prior to blending or after blending.

The mixture may be solution blended by sonication for a time period effective to disperse the particles within the composition. In one embodiment, the fluid may swell the composition during the process of sonication. The composition after processing may have less than about 100 parts per million of the solvent, and may have less than about 100 parts per million of the condensation catalyst.

The composition may be linear, branched or dendritic. The composition may have a molecular weight of greater than about 1,000 g/mol. In one embodiment, the molecular weight may be in a range of from about 1000 g/mol to 1200 g/mol, from 1200 g/mol to about 5000 g/mol, from about 5000 g/mol to about 10,000 g/mol, from about 10,000 to about 15,000 g/mol, from about 15,000 to about 20,000 g/mol, or from about 20,000 g/mol to about 100,000 g/mol, from about 100,000 g/mol to about 150,000 g/mol, from about 150,000 g/mol to about 200,000 g/mol, from about 200,000 g/mol to 250,000 g/mol, or greater than about 3000 g/mol.

The composition may have a decomposition temperature of at least 200 degrees Celsius. In one embodiment, the composition may have a decomposition temperature in the range of from about 200 degrees Celsius to about 250 degrees Celsius, from about 250 degrees Celsius to about 300 degrees Celsius, from about 300 degrees Celsius to about 350 degrees Celsius, from about 350 degrees Celsius to about 400 degrees Celsius, from about 400 degrees Celsius to about 420 degrees Celsius, from about 420 degrees Celsius to about 450 degrees Celsius, or greater than about 450 degrees Celsius.

In one embodiment, the composition may have a tensile strength in a range of from about 1 megapascal (MPa) to about 10 megapascal (MPa), from about 10 megapascal (MPa) to about 15 megapascal (MPa), from about 15 megapascal (MPa) to about 20 megapascal (MPa), from about 20 megapascal (MPa) to about 25 megapascal (MPa), or greater than 2 megapascal (MPa) as measured using ISO 527 on an Instron instrument. In another embodiment, the composition may have a percent of elongation of at least 1 percent. In one embodiment, the composition may have a percent elongation in the range of from about 1 percent to about 50 percent, from about 50 percent to about 100 percent, from about 100 percent to about 150 percent, from about 150 percent to about 250 percent, from about 250 percent to about 350 percent, from about 350 percent to about 450 percent, from about 450 percent to about 500 percent, from about 500 percent to about 650 percent, from about 650 percent to about 700 percent, from about 700 percent to about 750 percent, from about 750 percent to about 800 percent, or greater than about 50 from about 50 percent to about 100 percent, from about 100 percent to about 150 percent, from about 150 percent to about 250 percent, from about 250 percent to about 350 percent, from about 350 percent to about 450 percent as measured using ISO 527 on an Instron instrument.

In one embodiment, the composition may have a Shore-A Hardness in the range of from about 1 to about 25, from about 25 to about 30, from about 30 to about 35, from about 35 to about 45, from about 45 to about 50, from about 50 to about 55, from about 55 to about 60, from about 60 to about 75, from about 75 to about 80, from about 800 to about 90, from about 90 to about 95, or greater than about 35 as measured using ASTM D 2240.

In some embodiments, the composition may exclude or be free of components other than those described above as required. For example, the composition may be free of other thermoplastic materials—such as polyamides, polyesters, polyarylates, polyetherimides, polycarbonates, or polyolefins. And, the composition may comprise less than 0.1 weight percent of the specified component, or none of the specified component may be intentionally added.

In one embodiment, the compositions may be molded into useful articles. The composition may be formed by injection molding, extrusion molding, rotation molding, foam molding, calendar molding, blow molding, thermoforming, compaction, melt spinning, profile extrusion, film or sheet, plutrusion, rotation, fiber spinning, and the like.

The composition may be applied directly onto the surface of the conductive core by a suitable method such as extrusion coating to form a coated wire. For example, a coating extruder equipped with a screw, crosshead, breaker plate, distributor, nipple, and die can be used. The melted thermoplastic composition forms a covering disposed over a circumference of the conductor. Extrusion coating may employ a single taper die, a double taper die, other appropriate die or combination of dies to position the conductor centrally and avoid die lip build up.

The composition may be applied to an insulating layer previously formed on a conductive core or onto the surface of a predetermined number of wires or cables (which can be coated or uncoated) to form a covering disposed over the conductor. Additional layers may be applied to the covering. The thickness of the composition can vary and may be determined by the end use of the coated wire or cable. In one embodiment, the coating may have a thickness in a range of from about 0.03 millimeters to about 0.3 millimeters. In another embodiment, the wire has a thickness in a range of from about 0.3 millimeters to about 20 millimeters.

A suitable conductor may be round or oblong as a cross-sectional profile. The conductor may be used to transmit a signal. Exemplary signals include optical, electrical, and electromagnetic. Glass fibers are an optical conductor. Suitable electrically conductive cores include copper wire and aluminum wire. Others may include lead wire, wires of alloys, carbon, and the like.

The composition may be applied to an outer surface of a covering for the conductor. For example, an adhesion promoting layer may be disposed between the conductor and a layer of the composition. Or, the conductor may be coated with a metal deactivator layer prior to applying the covering by a layer of the composition. The intervening layer may include a thermoplastic or thermoset composition that, in some cases, is foamed.

The electrically conductive core can be a single wire or a plurality of wires. In some cases, a plurality of wires can be bundled and twisted or braided, similar to yarn or rope.

The cross-sectional area of the conductor and thickness of the covering may differ, and may be determined by the end use of the covered conductor. The covered conductors include those that carry an electric current, an electric signal, a light signal, and the like. The covered conductor may be useful as a: harness wire for an automobile, wire (cable) used to connect a vehicle and a trailer, wire for household electrical appliances, wire for electric power, wire for instruments, wires used in medical equipment including in vivo medical equipment, wire for information communication, wire for electric cars, ships, airplanes, and the like. In one embodiment, the covered conductor is an optical cable and can be used in interior applications (inside a building), exterior applications (outside a building) or both interior and exterior applications. Exemplary applications include data transmission networks and voice transmission networks such as telephone networks and local area networks (LAN). In addition to covered conductors the thermoplastic composition may be useful in aircraft wire guides, aircraft flooring, and flexible tubing—particularly in the medical field. Alternatively the composition may be molded or extruded to form articles such as sheets or trays when it may be needed for such articles to have combination of chemical resistance, heat aging, abrasion resistance and impact strength.

In one embodiment, the article may be an electrical conductor having an electrically conductive material covered by a coating layer of an electrically insulating formed from the reaction product of a poly(arylene ether) composition having a plurality of terminal groups; and a siloxane composition having a structure represented by Formula (I).

### EXAMPLES

The following examples illustrate methods and embodiments in accordance with the invention, and as such should not be construed as imposing limitations upon the claims. Unless specified otherwise, all ingredients may be commercially available from such common chemical suppliers as Alpha Aesar, Inc. (Ward Hill, Mass.), Sigma Aldrich, Spectrum Chemical Mfg. Corp. (Gardena, Calif.), and the like.

### Example 1

A 1 liter round bottom flask is charged 43.7 grams (g) of bifunctional polyphenylene ether (PPO), 300 milliliter (mL) of toluene, and 5.70 grams (i.e., about 0.056 moles) of triethylamine. The bifunctional polyphenylene ether has an interinsic viscosity of about 0.09 IV. The mixture is stirred. While stirring, 69.1 grams (g) of d28.8 eugenol siloxane bischloroformate (1:1 mole equivalence of —OCOCl to —OH from the PPO) in 100 milliliter (mL) of toluene is added via addition funnel over a period of approximately 30 minutes at room temperature. The stirring is continued until there is no indication of unreacted chloroformates as may be seen by blotting the reaction solution onto phosgene paper (about 1.5 hours). Isolation of the resulting polymer is performed by precipitation into methanol in a blender to afford a slightly rubbery, granular solid. Mn 19300, Mw 70060.

Examples 2-9 are synthesised using the above procedure using condensation of various amounts of PPO and siloxane composition in toluene, as given in Table 1.

TABLE 1

| | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|
| PPO IV | 0.06 | 0.06 | 0.06 | 0.09 | 0.09 | 0.09 | 0.12 | 0.12 | 0.12 |
| (deciliters/g) | | | | | | | | | |
| PPO Amt. | 43.3 | 29.7 | 22.7 | 54.6 | 35.3 | 27.5 | 75.2 | 45.0 | 41.0 |
| (wt. %) | | | | | | | | | |
| Eugenol | d13.7 | d31.0 | d48.0 | d13.7 | d31.0 | d48.0 | d13.7 | d31.0 | d48.0 |
| Siloxane | | | | | | | | | |
| Eugenol | 56.6 | 70.3 | 77.3 | 45.4 | 64.7 | 72.5 | 24.8 | 55.0 | 59.0 |
| Siloxane Amt. | | | | | | | | | |
| (wt. %) | | | | | | | | | |
| Mn | 18354 | 20771 | 16702 | 16124 | 17505 | 14763 | 14768 | 12754 | 13657 |
| Mw (g/mol) | 74112 | 79044 | 59041 | 57219 | 59339 | 58393 | 55580 | 41597 | 47697 |
| PDI | 4.04 | 3.81 | 3.54 | 3.55 | 3.57 | 3.96 | 3.76 | 3.26 | 3.50 |
| TGA | 228.3 | 376.1 | 393.2 | 214.9 | 395.2 | 411.6 | 241.6 | 384.6 | 382.8 |
| decomposition | | | | | | | | | |
| (° C.) | | | | | | | | | |
| Tensile | 8.57 | 5.45 | 2.48 | — | — | 2.18 | — | — | 7.86 |
| Strength | | | | | | | | | |
| (MPa) | | | | | | | | | |
| Elongation | 1.2 | 250 | 95.7 | — | — | 70.5 | — | — | 45 |
| (%) | | | | | | | | | |
| Shore A | 83.3 | 86.7 | 57.8 | — | 95.0 | 56.5 | — | — | 92 |
| Hardness | | | | | | | | | |
| Flexibility | Flexible | Flexible | Flexible | Brittle | Flexible | Flexible | Brittle | Brittle | Flexible |
| | @ 50° C. | @ RT | | | @ 50° C. | | | | |

The mechanical properties, including the tensile properties (percent elongation and tensile strength) are determined as per test procedure ISO 527 on an INSTRON instrument. The shore-A hardness device measures the surface of the molded part for physical hardness using a spring loaded probe measured according to ASTM D 2240. The molecular weight is measured on a Gel Permeation Chromotography instrument with chloroform as the mobile phase and polystyrene standards. The decomposition temperature (T_{decomp}) is measured using differential scanning calorimeter from TA instruments.

From Table 1 results, the samples' properties for the examples display good elongation and decomposition temperature. However, an increase in siloxane content may lower the tensile strength, elongation, and hardness. But, higher siloxane content may increase the decomposition temperature.

Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Similarly, “free” may be used in combination with a term, and may include an insubstantial number, or trace amounts, while still being considered free of the modified term.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be”.

Reactants and components referred to by chemical name or formula in the specification or claims hereof, whether referred to in the singular or plural, may be identified as they exist prior to coming into contact with another substance referred to by chemical name or chemical type (e.g., another reactant or a solvent). Preliminary and/or transitional chemical changes, transformations, or reactions, if any, that take place in the resulting mixture, solution, or reaction medium may be identified as intermediate species, master batches, and the like, and may have utility distinct from the utility of the reaction product or final material. Other subsequent changes, transformations, or reactions may result from bringing the specified reactants and/or components together under the conditions called for pursuant to this disclosure. In these other subsequent changes, transformations, or reactions the reactants, ingredients, or the components to be brought together may identify or indicate the reaction product or final material.

The foregoing examples are illustrative of some features of the invention. The appended claims are intended to claim the invention as broadly as has been conceived and the examples herein presented are illustrative of selected embodiments from a manifold of all possible embodiments. Accordingly, it is Applicants' intention that the appended claims not limit to the illustrated features of the invention by the choice of examples utilized. As used in the claims, the word “comprises” and its grammatical variants logically also subtend and include phrases of varying and differing extent such as for example, but not limited thereto, “consisting essentially of” and “consisting of:” Where necessary, ranges have been supplied, and those ranges are inclusive of all sub-ranges there between. It is to be expected that variations in these ranges will suggest themselves to a practitioner having ordinary skill in the art and, where not already dedicated to the public, the appended claims should cover those variations. Advances in science and technology may make equivalents and substitutions possible that are not now contemplated by reason of the imprecision of language; these variations should be covered by the appended claims.

1. A composition, comprising the reaction product of:
a poly(arylene ether) composition having a plurality of terminal groups; and
a siloxane composition having a structure represented by Formula (I) 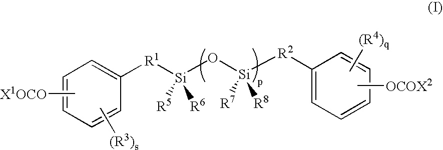
wherein R¹ and R² are a C₁ to about C₂₀ alkylene group; R³ and R⁴ are hydrogen, a C₁ to about C₂₀ aliphatic radical, a C₃ to about C₂₀ cycloaliphatic radical, or a C₆ to about C₃₀ aromatic radical; s and q are independently at each occurrence an integer in a range of from 0 to 4 inclusive; X¹ and X² are a halogen, a C₁ to about C₂₀ aliphatic radical, a C₃ to about C₂₀ cycloaliphatic radical, or a C₆ to about C₃₀ aromatic radical; and R⁵, R⁶, R⁷ and R⁸ are a hydrogen, a C₁ to about C₂₀ aliphatic radical, a C₃ to about C₂₀ cycloaliphatic radical, or a C₆ to about C₃₀ aromatic radical, and p is an integer greater than or equal to 1.

2. The composition as defined in claim 1, wherein X¹ and X² are a trifluoromethyl, a cyano, or an epoxy group and p is an integer in a range of from 1 to about 200 inclusive.

3. The composition as defined in claim 1, wherein the siloxane composition has a structure represented by Formula (II) 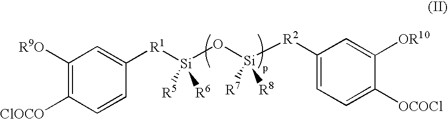
wherein R⁹ and R¹⁰ are, a C₁ to about C₂₀ aliphatic radical, a C₃ to about C₂₀ cycloaliphatic radical, or a C₆ to about C₃₀ aromatic radical, and p is an integer in a range of from 1 to about 200 inclusive.

4. The composition as defined in claim 1, wherein the poly(arylene ether) composition having structure represented by Formula (III) 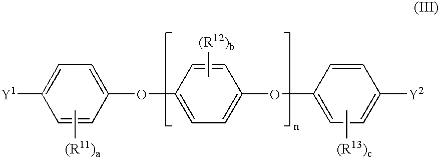
wherein R¹¹R¹² and R¹³ a halogen, a hydrogen, a C₁ to about C₂₀ aliphatic radical, a C₃ to about C₂₀ cycloaliphatic radical, or a C₆ to about C₃₀ aromatic radical; and Y¹ and Y² each are a reactive functional group; and a, b and c are independently at each occurrence an integer in a range of from 3 to about 200 inclusive.

5. The composition as defined in claim 1, wherein the poly(arylene ether) composition consists essentially of a bifunctional poly(phenylene ether) composition.

6. The composition as defined in claim 1, wherein the poly(arylene ether) composition has a structure represented by Formula (V) 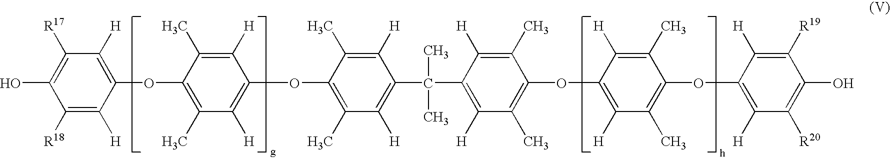
wherein R¹⁷, R¹⁸, R¹⁹ and R²⁰ are methyl or di-n-butylaminomethyl; and g and h are integers in a range of from 0 to about 200 inclusive.

7. The composition as defined in claim 1, wherein the poly(arylene ether) composition is present in an amount in a range of from about 5 weight percent to about 95 weight percent based on the total weight of the composition.

8. The composition as defined in claim 1, wherein the siloxane composition is present in an amount in a range of from about 5 weight percent to about 95 weight percent based on the total weight of the composition.

9. The composition as defined in claim 1, wherein the siloxane composition is present in an amount in a range of from about 30 weight percent to about 80 weight percent based on the total weight of the composition.

10. The composition as defined in claim 1, further comprising one or more additive selected from the group consisting of lubricants, flow modifiers, pigments, dyes, colorants, UV light stabilizers, anti-oxidants, impact modifiers, thixotropes, heat stabilizers, antidrip agents, plasticizers, mold release agents, nucleating agents, optical brighteners, anti-static agents, and blowing agents.

11. The composition as defined in claim 1, further comprising a flame retardant.

12. The composition as defined in claim 1, further comprising a flame proofing agent.

13. The composition as defined in claim 1, wherein the poly(arylene ether) has a number average molecular weight of at least about 5,000 measured using gel permeation chromatography using polystyrene standards.

14. The composition as defined in claim 1, wherein the poly(arylene ether) has a number average molecular weight in a range of from about 10,000 to about 150,000 measured using gel permeation chromatography using polystyrene standards.

15. The composition as defined in claim 1, wherein the composition has a tensile elongation in a range of from 1 percent to about 800 percent as determined by ISO 527

16. The composition as defined in claim 1, wherein the composition has a tensile strength in a range of from about 1 to about 40 megapascals as determined by ISO 527.

17. The composition as defined in claim 1, wherein the composition has a Shore-A Hardness in a range of from about 45 to about 95 as determined by ASTM D 2240.

18. The composition as defined in claim 1, wherein the composition is a thermoplastic.

19. The composition as defined in claim 1, wherein the composition is free of halogen.

20. The composition as defined in claim 1, wherein the composition has less than about 100 parts per million of a solvent.

21. The composition as defined in claim 1, wherein the composition has less than about 100 parts per million of a condensation catalyst.

22. A coated wire comprising a conductive wire and a coating formed from the composition as defined in claim 1.

23. A coated wire as defined in claim 22, wherein the wire has a thickness in a range of from about 0.1 millimeter to about 20 millimeters.

24. A coated conductor, comprising:
a core structure comprising a conductive material; and
coating disposed on a surface of the core structure, the coating comprising the reaction product of:
a poly(arylene ether) composition having a plurality of terminal groups; and
a siloxane composition having a structure represented by Formula (I) 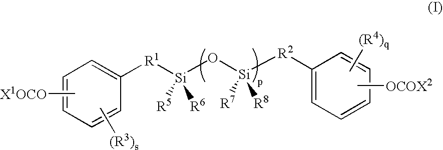
wherein R¹ and R² are a C₁ to about C₂₀ alkylene group; R³ and R⁴ are hydrogen, a C₁ to about C₂₀ aliphatic radical, a C₃ to about C₂₀ cycloaliphatic radical, or a C₆ to about C₃₀ aromatic radical; s and q are independently at each occurrence an integer in a range of from 0 to 4 inclusive; X¹ and X² are halogen, a C₁ to about C₂₀ aliphatic radical, a C₃ to about C₂₀ cycloaliphatic radical, or a C₆ to about C₃₀ aromatic radical; and R⁵, R⁶, R⁷ and R⁸ are a hydrogen, a C₁ to about C₂₀ aliphatic radical, a C₃ to about C₂₀ cycloaliphatic radical, or a C₆ to about C₃₀ aromatic radical, and p is an integer greater than or equal to 1.

25. A method, comprising:
reacting a terminal group of a poly(arylene ether) composition with a reactive functional group of a siloxane composition having a structure represented by Formula (I): 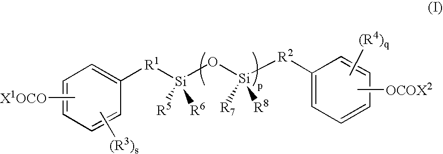
wherein R¹ and R² are a C₁ to about C₂₀ alkylene group; R³ and R⁴ are hydrogen, a C₁ to about C₂₀ aliphatic radical, a C₃ to about C₂₀ cycloaliphatic radical, or a C₆ to about C₃₀ aromatic radical; s and q are independently at each occurrence an integer in a range of from 0 to 4 inclusive; X¹ and X² are halogen, a C₁ to about C₂₀ aliphatic radical, a C₃ to about C₂₀ cycloaliphatic radical, or a C₆ to about C₃₀ aromatic radical; and R⁵, R⁶, R⁷ and R⁸ are a hydrogen, a C₁ to about C₂₀ aliphatic radical, a C₃ to about C₂₀ cycloaliphatic radical, or a C₆ to about C₃₀ aromatic radical, and p is an integer greater than or equal to 1.

26. The method as defined in claim 25, further comprising solvating at least one of the poly(arylene ether) composition or the siloxane composition prior to reacting.

27. The method as defined in claim 25, further comprising catalyzing a reaction between the terminal groups and chloroformate groups of the siloxane composition.

28. The method as defined in claim 25, wherein reacting comprises extruding.

29. A composition, comprising a structure represented by Formula (VI) 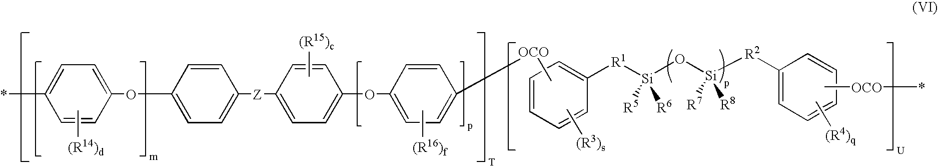
wherein R¹ and R² independently are a C₁ to about C₂₀ alkylene group; R³ and R⁴ are hydrogen, a C₁ to about C₂₀ aliphatic radical, a C₃ to about C₂₀ cycloaliphatic radical, or a C₆ to about C₃₀ aromatic radical; s and q are independently at each occurrence an integer in a range of from 0 to 4 inclusive; and R⁵, R⁶, R⁷ and R⁸ are a hydrogen, a C₁ to about C₂₀ aliphatic radical, a C₃ to about C₂₀ cycloaliphatic radical, or a C₆ to about C₃₀ aromatic radical, and p is an integer greater than or equal to 1; R⁴, R¹⁵ and R¹⁶ are a halogen, a C₁ to about C₂₀ aliphatic radical, a C₃ to about C₂₀ cycloaliphatic radical, or a C₆ to about C₃₀ aromatic radical; d, e and f are independently at each occurrence integers in a range of from 0 to 4; Z is a bond, oxygen, sulfur, a C₁ to about C₂₀ aliphatic radical, or C₆ to about C₃₀ aromatic radical; m and p are integers from 5 to about 100; and T and U independently are integers greater than or equal to 1.
